(19) United States
(12) Patent Application Publication
(10) Pub. No.: US 2026/0142612 A1
(43) Pub. Date: May 21, 2026

(54) MODULAR SOLAR PANEL AND SOLAR PANEL SYSTEM COMPRISING THE SAME

(71) Applicant: Hanvixolar lnc., Gunpo-si (KR)

(72) Inventor: Joon Sung LEE, Gunpo-si (KR)

(21) Appl. No.: 19/382,471

(22) Filed: Nov. 7, 2025

(30) Foreign Application Priority Data
Nov. 20, 2024 (KR) 10-2024-0166071

(51) Int. Cl. H02S 30/10; H02S 30/20; H02S 40/36

(52) U.S. Cl. CPC H02S 30/10; H02S 30/20; H02S 40/36

(57) ABSTRACT

According to one embodiment, a modular solar panel includes a solar module in which a plurality of solar cell pieces are arranged on a light-receiving surface configured to receive sunlight, a panel frame provided in a form surrounding the solar module and having a plurality of magnetic pockets arranged thereon, a plurality of magnets arranged in the plurality of magnetic pockets, respectively, and bezel electrodes arranged to be spaced apart from each other in an edge region of the panel frame.

### CROSS REFERENCE TO RELATED APPLICATION OF THE DISCLOSURE

The present application claims the benefit of Korean Patent Application No. 10-2024-0166071 filed in the Korean Intellectual Property Office on 11.20.2024, the entire contents of which are incorporated herein by reference.

### Field of the Disclosure

The present disclosure relates to a solar panel and a solar panel system, and more particularly, to a modular solar panel and a solar panel system each using a magnet.

### Background of the Related Art

As reserves of existing energy resources such as oil or coal are decreasing and environmental pollution caused by existing energy resources becomes serious, there is an increasing interest in alternative energy sources to replace the existing energy resources. Among the alternative energy sources, a solar cell is an eco-friendly energy device that utilizes infinitely provided sunlight but does not cause environmental pollution, and research on relevant technologies is being actively conducted.

The solar cell is an electrical element configured to convert solar energy into electricity, and currently, a crystalline silicon-based material is mainly used for the solar cell.

Recently, not only various technologies for increasing efficiency of the solar cell, but also technologies utilizing the solar cell, i.e., technologies relevant to various devices and services using solar panels are being variously proposed. As an example, technologies of connecting a plurality of solar cells with each other to implement solar panel products for charging smartphones, solar panel products for charging auxiliary batteries, foldable-type solar panels, flat-type solar panels, etc. are being introduced.

Patent Document 1 discloses a mono-facial light-receiving solar cell applicable to small-scale power-consuming devices such as sign devices. According to this technology, a structure configured to provide a mounting space of a solar cell panel and a solar panel structure configured to include a solar cell panel mounted in the structure are provided. It is disclosed that this allows to perform stable solar power generation regardless of a position of the sun, and simultaneously, improve convenience of installation and maintenance.

Patent Document 2 discloses a hand-held type solar cell panel held by a person and capable of charging various portable devices. The hand-held type solar cell panel includes a printed circuit board on which a circuit pattern is arranged, and a substrate for a solar cell panel including a first plated layer having a shape of a discontinuous strip arranged along an upper surface, a lower surface, and sides of edges of the printed circuit board.

Such general solar power generation devices (solar charging devices, solar panels, etc.) may help to improve convenience to a certain degree, but still have various problems.

In detail, since the general solar power generation devices receive sunlight to generate electricity, a power generation output is determined in proportion to conversion efficiency and a size of a panel capable of absorbing sunlight. However, since a light-receiving area is determined constantly in the general solar power generation devices, an amount of power generation is fixed. Thus, an amount of power generation cannot be changed or may be structurally very difficult to change.

In addition, due to a standardized shape of a solar panel, an area receiving sunlight cannot be increased, and when there is an obstacle, the solar panel cannot be installed, and installation can be performed only when a space having a certain size is secured. Therefore, efficient utilization of a space cannot be performed or is very difficult to perform.

In addition, it is also difficult to cope with a change in a demand for power as needed. That is, since it is difficult to increase or decrease an amount of power generation, a solar panel needs to be replaced when power is to be generated in correspondence with an amount other than a determined power generation amount. This eventually causes an increase in waste of resources such as generation of waste panels, and an increase in costs of management such as maintenance, etc.

Therefore, to obviate those problems, there is a need to develop a new concept of a solar panel structure which allows simple mechanical and electrical connections and variable installations as needed.

### Prior Art Documents

### Patent Documents

(Patent Document 1) Korean Patent Registration No. 10-1952824 (published on February 28, 2019)

(Patent document 2) Korea Patent Registration No. 10-1700955 (published on January 31, 2017)

### SUMMARY OF THE DISCLOSURE

Accordingly, the present disclosure has been made in view of the above-mentioned problems occurring in the related art, and it is an object of the present disclosure to provide a modular solar panel that allows very easy connection and combination between solar panels, simple structural and electrical connections, and variable installation as needed, by using contact magnets provided in an exposed form on sides of frames of the solar panels.

The present disclosure may be embodied in many different forms and should not be construed as being limited to the embodiments set forth herein. Additional aspects will be set forth in part in the description which follows and, in part, will be apparent from the description, or may be learned by practice of the presented embodiments.

To accomplish the above-mentioned objects, according to one embodiment of the present disclosure, there is provided a modular solar panel including a solar module in which a plurality of solar cell pieces are arranged on a light-receiving surface configured to receive sunlight, a panel frame provided in a form surrounding the solar module and having a plurality of magnetic pockets arranged thereon, a plurality of magnets arranged in the plurality of magnetic pockets, respectively, and bezel electrodes arranged to be spaced apart from each other in an edge region of the panel frame

In an embodiment of the present disclosure, the bezel electrode may include first electrodes arranged in corner regions of the panel frame, respectively and second electrodes arranged on sides of the panel frame.

In an embodiment of the present disclosure, the bezel electrode may be arranged in a form wrapping around the panel frame to be coupled to the panel frame.

In an embodiment of the present disclosure, the first electrodes and the second electrodes may cover the plurality of magnets arranged in the plurality of magnet pockets, respectively.

In an embodiment of the present disclosure, the plurality of magnetic pockets may include a plurality of magnetic pockets arranged to be spaced apart from each other at an edge of the panel frame.

In an embodiment of the present disclosure, the plurality of magnetic pockets may be arranged to be concave in a shape corresponding to a shape of each of the plurality of magnets.

In an embodiment of the present disclosure, the plurality of magnets arranged to be spaced apart from each other may be exposed through an outer surface of the panel frame, and the plurality of magnets may be arranged so that polarities exposed through the outer surface of the panel frame alternate with each other.

To accomplish the above-mentioned objects, according to another embodiment of the present disclosure, there is provided a solar panel system including a plurality of modular solar panels magnetically coupled to be electrically connected to each other, and a controller magnetically coupled to one side of at least one of the plurality of modular solar panels and configured to supply electric energy generated from the plurality of modular solar panels to an external terminal, wherein the plurality of modular solar panels each include a solar module in which a plurality of solar cell pieces are arranged on a light-receiving surface configured to receive sunlight, a panel frame provided in a form surrounding the solar module and having magnetic pockets arranged thereon, magnets arranged in the magnetic pockets, respectively, and bezel electrodes arranged to be spaced apart from each other in an edge region of the panel frame.

In an embodiment of the present disclosure, the plurality of modular solar panels may include a first modular solar panel and a second modular solar panel, and, and the bezel electrodes may include first electrodes arranged in corner regions of the panel frame, respectively, and second electrodes having opposite charges to the first electrodes and arranged on sides of the panel frame, respectively.

In an embodiment of the present disclosure, the first modular solar panel and the second modular solar panel combined with each other may be electrically connected to each other according to contact between the first electrodes having corresponding charges and contact between the second electrodes.

### BRIEF DESCRIPTION OF THE DRAWINGS

FIG. 1 is a schematic diagram illustrating a modular solar panel according to one embodiment of the present disclosure.

FIG. 2 is a schematic diagram illustrating the modular solar panel other than bezel electrodes according to one embodiment of the present disclosure.

FIG. 3 is a schematic diagram illustrating a solar panel and a panel frame according to one embodiment of the present disclosure.

FIG. 4 is an enlarged view for explaining in detail the bezel electrodes arranged on the panel frame according to one embodiment of the present disclosure.

FIG. 5 is an enlarged diagram illustrating magnets covered by the bezel electrodes according to one embodiment of the present disclosure.

FIG. 6 is a schematic diagram illustrating a combination between modular solar panels according to one embodiment of the present disclosure.

FIG. 7 is an enlarged cross-sectional view illustrating the combination between the modular solar panels according to the embodiment of FIG. 6.

FIG. 8 is a diagram illustrating an arrangement of another combination between modular solar panels according to one embodiment of the present disclosure.

FIG. 9 is an enlarged cross-sectional view illustrating the another combination between the modular solar panels according to the embodiment of FIG. 8.

FIG. 10 is a diagram illustrating a solar panel system according to one embodiment of the present disclosure.

### DETAILED DESCRIPTION OF THE PREFERRED EMBODIMENT

Hereinafter, the present disclosure will be described in detail with reference to the accompanying drawings. The present disclosure may, however, be implemented in many different forms and should not be construed as being limited to the embodiments set forth herein. In the description of the present disclosure, certain detailed explanations are omitted when it is deemed that they may unnecessarily obscure the essence of the present disclosure. Like numbers refer to like elements throughout the specification.

It will be understood that when an element is referred to as being "connected to (combined with, in contact with, or coupled to)" another element, it may be "directly connected" to the other element, or "indirectly connected to" the other element with intervening elements therebetween. In addition, it will be further understood that the terms "comprises," "comprising," "includes," and/or "including," when used herein, specify the presence of components, but do not preclude the presence or addition of one or more other components, unless otherwise specified.

The terms used in the present specification are merely used to describe particular embodiments, and are not intended to limit the inventive concept. An expression used in the singular encompasses the expression of the plural, unless it has a clearly different meaning in the context. In the present specification, it is to be understood that the terms such as "including" or "having," etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Hereinafter, an embodiment of the present disclosure will be described in detail with reference to the accompanying drawings.

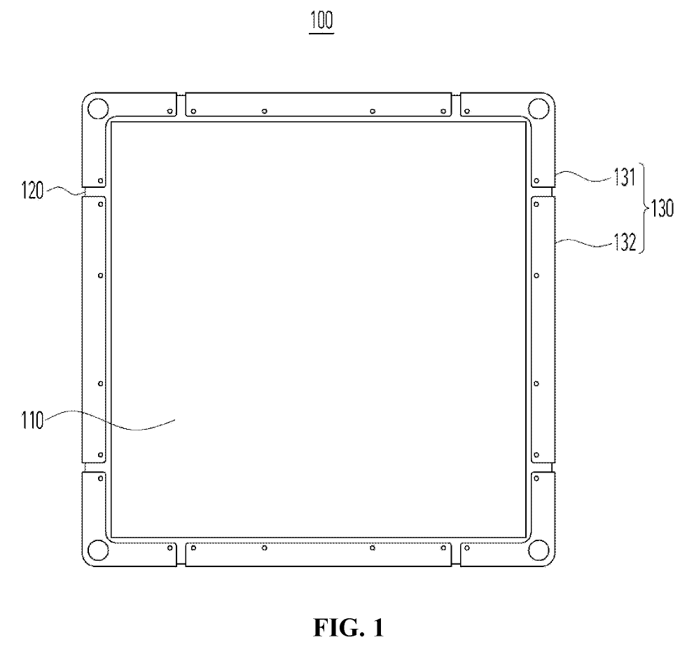

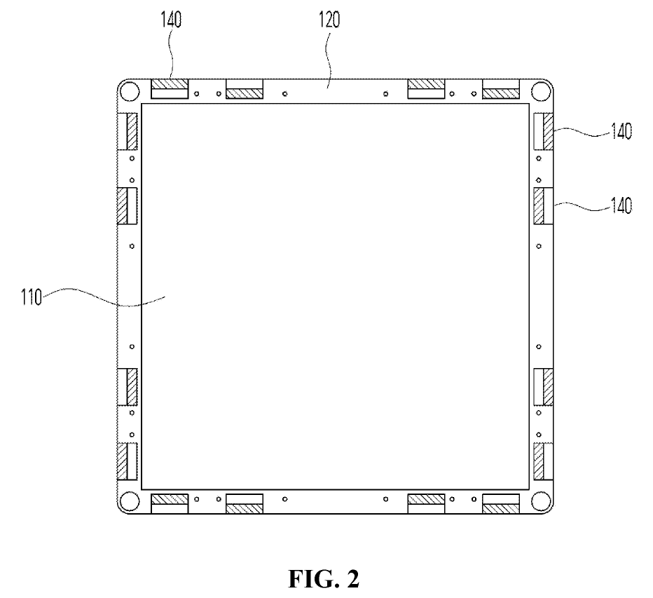

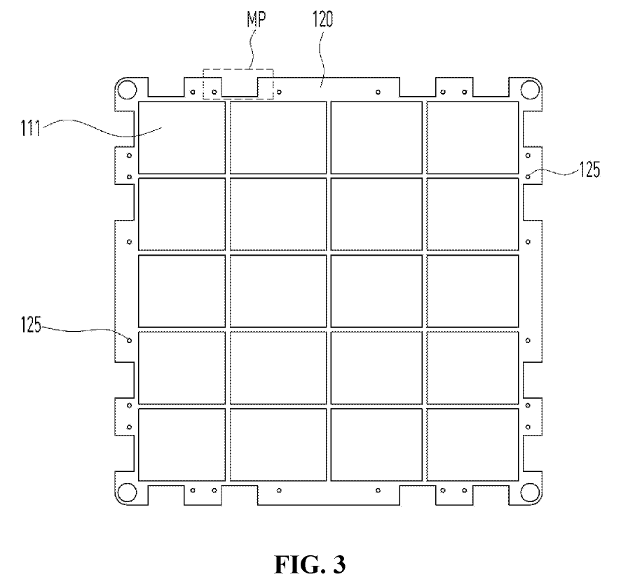

FIG. 1 is a schematic diagram illustrating a modular solar panel according to one embodiment of the present disclosure. FIG. 2 is a schematic diagram illustrating the modular solar panel other than bezel electrodes according to one embodiment of the present disclosure. FIG. 3 is a schematic diagram illustrating a solar panel and a panel frame according to one embodiment of the present disclosure.

Referring to FIGS. 1 to 3, a modular solar panel 100 in the present disclosure includes a solar module 110, a panel frame 120, bezel electrodes 130, and magnets 140.

The solar module 110 functions to receive sunlight to generate energy. As shown in FIG. 3, the solar module 110 may include a plurality of solar cell pieces 111 arranged on a light-receiving surface configured to receive sunlight. A number of the solar cell pieces 111 arranged on the modular solar panel 100 may be designed to be changed depending on a size of the solar cell pieces that have been manufactured.

The panel frame 120 may be provided in a form surrounding the solar module 110, as shown in FIG. 3. The panel frame 120 may be arranged in an edge region of the solar module 110. According to an embodiment of the present disclosure, the solar module 110 in which the plurality of solar cell pieces 111 are arranged may be implemented to have a quadrilateral shape. Accordingly, the panel frame 120 may also be implemented in a quadrilateral shape corresponding to the shape of the solar module 110.

A magnetic pocket MP may be arranged on an edge of the panel frame 120. The magnetic pocket MP is a space in which each of the magnets 140 may be placed, and may have a concave shape.

A plurality of magnetic pockets MP may be arranged to be spaced apart from each other on the edge of the panel frame 120.

According to one embodiment of the present disclosure, four magnetic pockets MP may be arranged on each side of the panel frame 120. That is, since the panel frame 120 has a quadrilateral shape, sixteen magnetic pockets MP may be arranged on the panel frame 120.

In particular, the magnetic pockets MP may be arranged to be concentrated near corners of the panel frame 120. For example, four magnetic pockets MP arranged on one side of the panel frame 120 may be placed such that two magnet pockets are arranged in each of both corner regions.

The magnetic pockets MP may be arranged to be concave in a shape corresponding to a shape of each of the magnets 140.

The magnets 140 are provided to be combined with another modular solar panel, and may be arranged to be inserted into in the magnet pockets MP of the panel frame 120, respectively. The magnets 140 may have a quadrilateral shape corresponding to a shape of each of the magnet pockets MP having quadrilateral shape.

Referring to FIG. 2, the magnets 140 may be arranged to be inserted into the magnet pockets MP such that one surface of each of the magnet 140 is exposed. As such, the magnets 140 arranged in the plurality of magnet pockets MP, respectively, may be arranged such that polarities exposed through an outer surface of the panel frame 120 alternate between opposite polarities.

As one example, when an exposed surface of a magnet 140 arranged in a magnet pocket MP is a North pole (N-pole), an exposed surface of another magnet 140 arranged in an adjacent magnet pocket MP may be arranged as a South pole (S-pole).

The bezel electrodes 130 are arranged in a form that surrounds the panel frame 120 to be combined with the panel frame 120. The bezel electrodes 130 may be arranged to be spaced apart from each other in an edge region of the panel frame 120.

The bezel electrodes 130 may include first electrodes 131 and second electrodes 133. For example, the first electrodes 131 may be positive (+) electrodes and the second electrodes 133 may be negative (-) electrodes.

In detail, the first electrodes 131 may be arranged in corner regions of the panel frame 120, and the second electrodes 133 may be arranged on sides of the panel frame 120 (see FIG. 1).

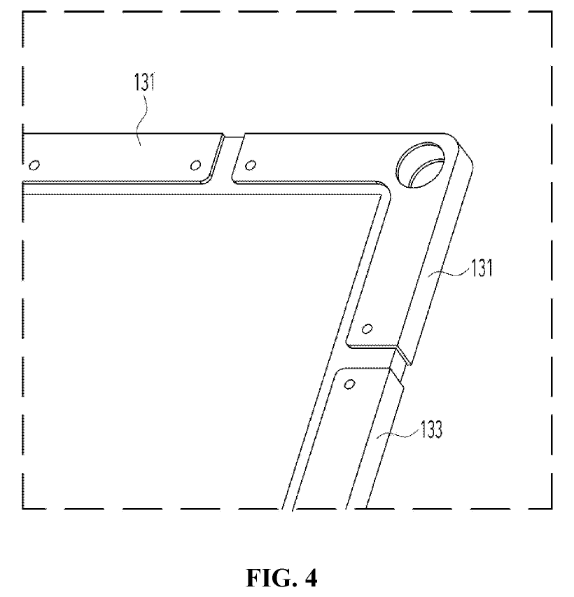

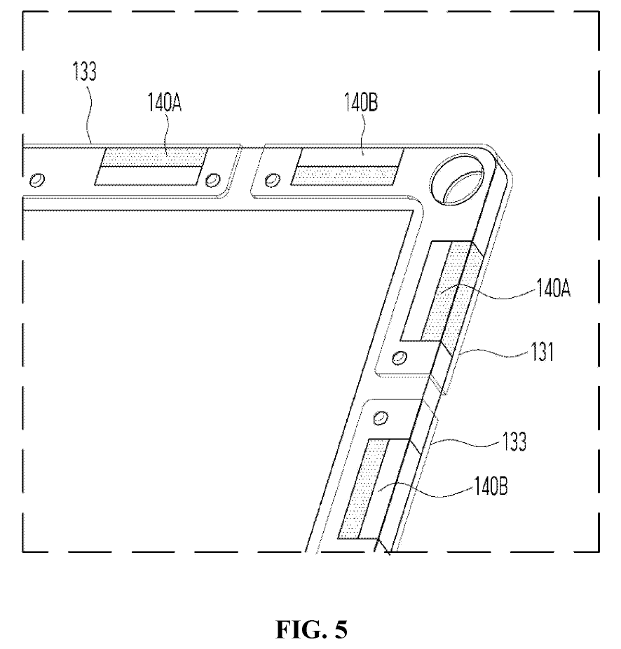

FIG. 4 is an enlarged view for explaining in detail the bezel electrodes arranged on the panel frame according to one embodiment of the present disclosure. FIG. 5 is an enlarged diagram illustrating magnets covered by the bezel electrodes according to one embodiment of the present disclosure.

Referring to FIG. 4, the first electrodes 131 may be provided in a form that wraps around a corner of the panel frame 120, and the second electrodes 133 may be provided in a form that wraps around portions of sides of the panel frame 120. The first electrodes 131 and the second electrodes 133 may be provided to be spaced apart from each other.

According to an embodiment of the present disclosure, the first electrodes 131 may have a bent shape corresponding to a corner shape of the panel frame 120. For example, the first electrodes 131 may be implemented to have a shape of a letter "ㄱ" or "ㄴ." The second electrodes 133 may be implemented in a straight-line shape corresponding to a shape of a side portion of the panel frame 120. For example, the second electrodes 133 may be implemented to have a shape of a letter "1."

Referring to FIG. 5, the first electrodes 131 and the second electrodes 133 may cover a plurality of the magnets 140 arranged in the magnet pockets MP.

The magnets covered by the first electrodes 131 may be arranged on different sides of the panel frame 120, respectively.

According to an embodiment of the present disclosure, a magnet covered by the first electrodes 131 and arranged on a first side of the panel frame 120 may be a magnet 140A (hereinafter, a first type magnet) of which one surface exposed toward an outer surface of the panel frame 120 is a south (S) pole, and a magnet covered by the first electrodes 131 and arranged on a second side of the panel frame 120 may be a magnet 140B (hereinafter, a second type magnet) of which one surface exposed toward an outer surface of the panel frame 120 is a north (N) pole. However, this is just one example, and the first type magnets and the second type magnets may be arranged in reverse.

The magnets covered by the second electrodes 133 may be provided on the same sides of the panel frame 120. Some magnets covered by the second electrodes 133 may be placed at positions adjacent to magnets covered by a first electrode 131 arranged at a first corner of the panel frame 120, and other magnets covered by the second electrodes 133 may be placed at positions adjacent to magnets covered by another first electrode 131 positioned at a second corner of the panel frame 120, respectively.

Referring to FIG. 5, a second electrode 133 arranged on the first side of the panel frame 120 may cover a second type magnet 140B provided in a position adjacent to the first type magnet 140A covered by the first electrodes 131, and a first type magnet 140A (not shown in FIG. 5) arranged on the first side of the panel frame 120 to be spaced apart from the second type magnet 140B by a certain distance. That is, the first type magnet 140A and the second type magnet 140B having different polarities may be respectively placed on an inner side of both end portions of the second electrode 133.

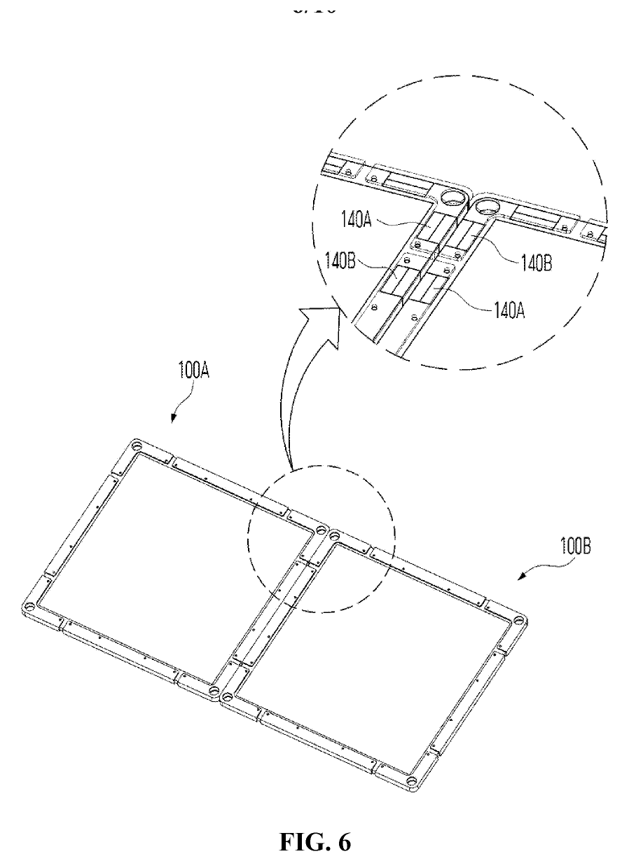

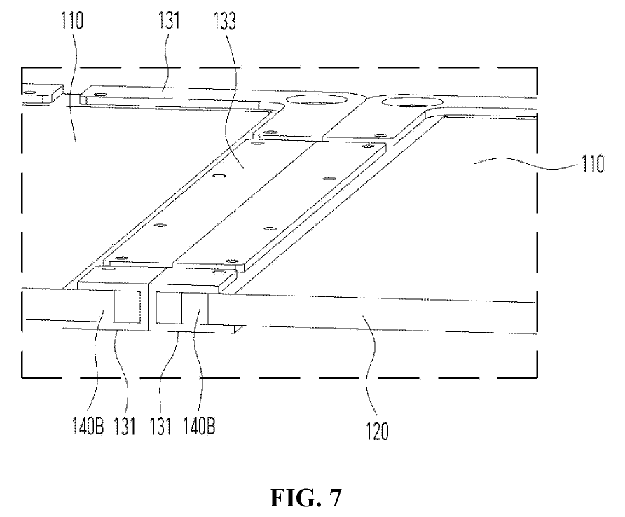

FIG. 6 is a schematic diagram illustrating a combination between modular solar panels according to one embodiment of the present disclosure. FIG. 7 is an enlarged cross-sectional view illustrating the combination between the modular solar panels according to the embodiment of FIG. 6.

In this embodiment, a first modular solar panel 100A and a second modular solar panel 100B may be configured as identical solar panels having a same configuration, shape, size, arrangement, and the like.

The first modular solar panel 100A and the second modular solar panel 100B may be magnetically coupled to be electrically connected to each other. That is, the first modular solar panel 100A and the second modular solar panel 100B may be mutually combined with each other using magnets arranged on respective panel frames 120.

In detail, since the first modular solar panel 100A and the second modular solar panel 100B have a same structure, when the second modular solar panel 100B is combined with one side of the first modular solar panel 100A, magnets on sides brought into contact with each other are arranged to have different polarities. Thus, the first and second modular solar panels 100A and 100B, when being brought closer, may be automatically combined with each other due to attractive force between the magnets. Accordingly, precise physical contact between the two solar panels is obtained due to the attractive force of the magnets, thereby resulting in close contact between the two solar panels.

When the first modular solar panel 100A and the second modular solar panel 100B are combined with each other using the magnets 140, the first electrodes 131 and the second electrodes 133 arranged on sides of each modular solar panel come into contact with each other, thereby establishing an electrical circuit. Thus, the first modular solar panel 100A and the second modular solar panel 100B may be electrically connected to each other.

In detail, when the two modular solar panels 100A and 100B are brought into close contact due to attractive force of magnets, the first electrodes 131 of the first modular solar panel 100A and the first electrodes 131 of the second modular solar panel 100B come into contact with each other, and likewise, the second electrodes 133 of the respective solar panels also come into contact with each other. This allows the solar panels to be connected in parallel with each other.

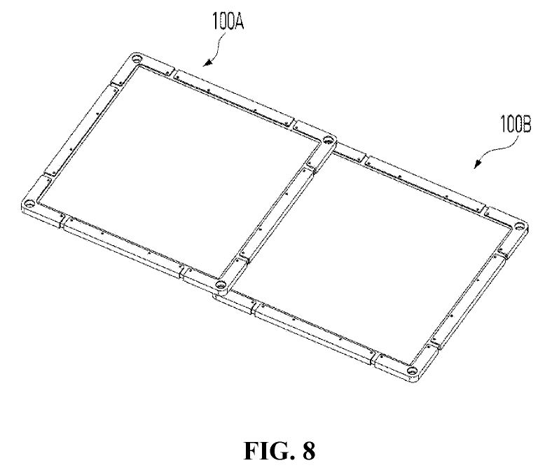

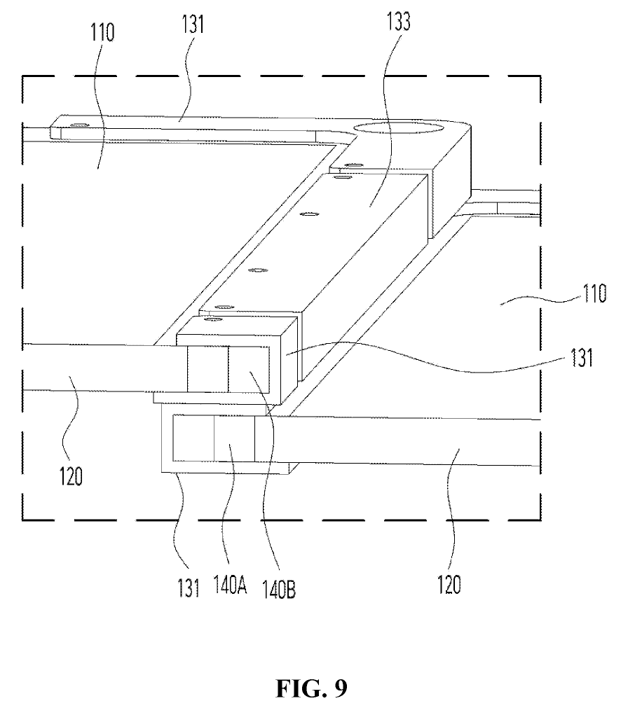

FIG. 8 is a diagram illustrating an arrangement of another combination between modular solar panels according to one embodiment of the present disclosure. FIG. 9 is an enlarged cross-sectional view illustrating the another combination between the modular solar panels according to the embodiment of FIG. 8.

Referring to FIGS. 8 and 9, it may be checked that even when the first modular solar panel 100A and the second modular solar panel 100B are combined with each other in a state in which sides thereof in contact overlap each other, the two solar panels may be electrically connected to each other.

According to the present embodiment, the first modular solar panel 100A and the second modular solar panel 100B may not be placed horizontally, but may be arranged to have a height difference. Referring to FIG. 9, an S pole located on an inner side of a second type magnets 140B arranged on a side of the first modular solar panel 100A may be positioned on an N pole located on an inner side of a first type magnet 140A arranged on a side of the second modular solar panel 100B to come into contact with each other. Accordingly, the first electrodes 131 and the second electrode 133 arranged on sides of the modular solar panels, respectively, also come into contact with each other.

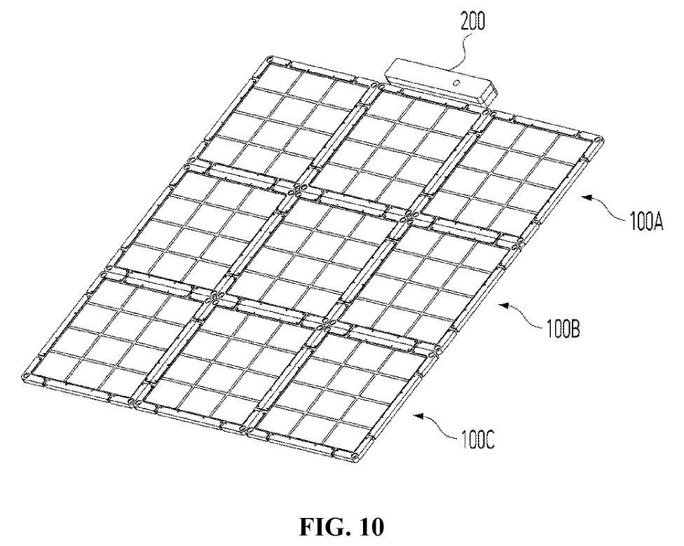

FIG. 10 is a diagram illustrating a solar panel system according to one embodiment of the present disclosure. The solar panel system in the present disclosure may include a plurality of modular solar panels 100 and a controller 200. At this time, a number of the modular solar panels 100 may be freely set as long as at least two modular solar panels 100 are present.

The modular solar panel 100 according to the present embodiment has been described above in detail with reference to FIGS. 1 to 5, and thus, will not be described here again.

The controller 200 in the present disclosure may collect electric energy (power) generated from modular solar panels 100A, 100B, and 100C and supply the generated electric energy to an external terminal. For example, the external terminal may be a mobile phone, a small electronic device, or a charging device (e.g., a secondary battery). The controller 200 is a device configured to supply electric energy to the external terminal, and may function as a direct current (DC)/DC converter.

On one side of the controller 200, a magnet capable of being mechanically coupled to the magnets 140 arranged on a side of the panel frame 120 may be arranged. In addition, a connection terminal configured to supply electric energy to the external terminal may be arranged on another side of the controller 200.

The controller 200 in the present disclosure is not fixedly positioned at a particular location, i.e., on one side or a rear surface of a particular modular solar panel, but may be selectively positioned (non-fixed type) on one side of one modular solar panel among a plurality of modular solar panels connected in parallel with each other to receive a supply of electric energy.

As another example, a plurality of controllers 200 in the present disclosure may be present, and may be individually attached to modular solar panels 100 connected in parallel with each other, respectively. The controllers 200 may each receive a supply of electric energy from a modular solar panel 100 arranged at one side thereof. That is, a plurality of modular solar panels connected in parallel with each other may be multiply-connected to several controllers.

According to an embodiment of the present disclosure, connection and combination between solar panels may be very easily performed using contact magnets provided in an exposed form on sides of frames of the solar panels. Accordingly, the modular solar panel in the present disclosure allows simple structural and electrical connections, and variable installation as needed.

By using a solar panel according to an embodiment of the present disclosure, a light-receiving area may be easily adjusted according to a required amount of power generation. In addition, in the presence of an obstacle or according to various needs (e.g., for an aesthetic reason or for implementation of various functions using non-power generation units), panels may be combined with each other in various forms, thereby greatly improving space utilization. In addition, since a combination between panels is simple and stable fixing may be performed, convenience of installation and maintenance may be greatly improved.

Effects of the present disclosure are not limited to the effects described above, and should be understood to include all effects that may be inferred from configurations described in the description or recited in claims of the present disclosure.

The above description has been made with reference to the embodiments, but it is merely illustrative. It will be apparent that other changes and applications can be made by those skilled in the art to which the present disclosure belong without departing from substantial features of the embodiments of the present disclosure. Therefore, the above-described embodiments should be considered in a descriptive sense only and not for purposes of limitation. For example, each component described in singular form may be executed in a distributed form. Likewise, components described in a distributed form may be executed in a combined form.

The scope of the present disclosure is to be basically determined by the scope defined by the appended claims, but not only the configurations derived from the claims, but also all changes or variations within the scope of the claims and their equivalents are to be construed as being included in the present disclosure.

What is claimed is:

1. A modular solar panel comprising:
a solar module in which a plurality of solar cell pieces are arranged on a light-receiving surface configured to receive sunlight;
a panel frame provided in a form surrounding the solar module and having a plurality of magnetic pockets arranged thereon;
a plurality of magnets arranged in the plurality of magnetic pockets, respectively; and
bezel electrodes arranged to be spaced apart from each other in an edge region of the panel frame.

2. The modular solar panel of claim 1, wherein the bezel electrodes comprise:
first electrodes arranged in corner regions of the panel frame, respectively; and
second electrodes arranged on sides of the panel frame.

3. The modular solar panel of claim 2, wherein the bezel electrodes are arranged in a form wrapping around the panel frame to be coupled to the panel frame.

4. The modular solar panel of claim 3, wherein the first electrodes and the second electrodes cover the plurality of magnets arranged in the plurality of magnet pockets, respectively.

5. The modular solar panel of claim 1, wherein the plurality of magnetic pockets comprise a plurality of magnetic pockets arranged to be spaced apart from each other at an edge of the panel frame.

6. The modular solar panel of claim 5, wherein the plurality of magnetic pockets are arranged to be concave in a shape corresponding to a shape of each of the plurality of magnets.

7. The modular solar panel of claim 1, wherein the plurality of magnets arranged to be spaced apart from each other are exposed through an outer surface of the panel frame, and
the plurality of magnets are arranged so that polarities exposed through the outer surface of the panel frame alternate with each other.

8. A solar panel system comprising:
a plurality of modular solar panels magnetically coupled to be electrically connected to each other; and
a controller magnetically coupled to one side of at least one of the plurality of modular solar panels and configured to supply electric energy generated from the plurality of modular solar panels to an external terminal,
wherein the plurality of modular solar panels each comprise a solar module in which a plurality of solar cell pieces are arranged on a light-receiving surface configured to receive sunlight, a panel frame provided in a form surrounding the solar module and having magnetic pockets arranged thereon, magnets arranged in the magnetic pockets, respectively, and bezel electrodes arranged to be spaced apart from each other in an edge region of the panel frame.

9. The solar panel system of claim 8, wherein the plurality of modular solar panels comprise a first modular solar panel and a second modular solar panel, and
wherein the bezel electrodes comprise:
first electrodes arranged in corner regions of the panel frame, respectively; and
second electrodes having opposite charges to the first electrodes and arranged on sides of the panel frame, respectively.

10. The solar panel system of claim 9, wherein the first modular solar panel and the second modular solar panel combined with each other are electrically connected to each other according to contact between the first electrodes having corresponding charges and contact between the second electrodes.
